(19) United States
(12) Patent Application Publication
(10) Pub. No.: US 2011/0049125 A1
(43) Pub. Date: Mar. 3, 2011

(54) HIGH EFFICIENCY ELECTRICAL OUTDOOR BARBECUE DEVICE

(76) Inventor: WILLIAM HOME, Taipei (TW)

(21) Appl. No.: 12/549,371

(22) Filed: Aug. 28, 2009

(51) Int. Cl. A21B 1/22; H05B 3/68; A47J 37/07

(52) U.S. Cl. 219/405; 219/450.1; 99/450

(57) ABSTRACT

A high efficiency electrical outdoor barbecue device includes plural arc reflective boards that juxtapose and are spaced from each other to define a residue discharge gap, heating tube connection end protection boxes, heating tubes, shielding screens, and roasting gratings, which are sequentially deposited, from lower side to upper side, in a roasting basin that has a top opening to which a cover is pivotally connected. Opposite ends of the heating tubes are respectively positioned in and supported by the protection boxes, which are fit into and retained by positioning cavities defined in corresponding walls of the basin. The shielding screens are set above and thus protect the heating tubes from being stained by drippings of the roasted food. The arc reflective boards are set below the heating tubes to reflect the infrared light and heat generated by the heating tubes toward the roasting gratings for fully heating the roasted foods.

### (a) TECHNICAL FIELD OF THE INVENTION

The present invention generally relates to a high efficiency electrical outdoor barbecue device, and more particularly to a novel structure of an electrical outdoor barbecue oven, which aims to provide high electrical-thermal efficiency, to reduce power consumption, to incorporate safety protection of heating tubes against impact and staining, and to make a reflective heating mechanism easy to withdraw for cleaning.

### (b) DESCRIPTION OF THE PRIOR ART

Gas-burning roasting ovens and carbon-burning roasting ovens are two of the most commonly seen roasting and cooking devices. The ovens are disadvantageous in that they may easily cause fire catastrophes, make incomplete combustions of the fuels, and only have low burning efficiency. For example, burning of fuel gas radiates infrared light to cook food, which may raise the temperature of a roasting grating up to 200° C. within 12 minutes, but at the expense of a heat consumption of 4,800 BTU.

Outdoor cooking and roasting can also be performed with ovens other than gas-burning ovens and carbon-burning ovens. Electrical outdoor barbecue ovens, which have an oven structure suitable for long term arrangement in an outdoor condition was long early available, and this offers an excellent alternative to consumers who have a house-side yard in which electricity supply is easily available, for there will be no smoke generated by burning carbons, which causes pollution to the environments and the atmosphere and there will also be no damage to human beings or other living things due to leak of gas or explosion caused by anciently setting a fire in a high-pressure gas supply source, which often leads to a fire catastrophe.

The conventional electrical outdoor barbecue oven uses a conventional electrical heating tube as a heat source. A disadvantage of heating realized through the conventional electrical heating tube is that temperature rise is very slow and distribution of temperature between low and high temperatures is not uniform. Insufficient temperature extends the time required for pre-heating and cooking food. In other words, the thermal efficiency is low. Further, the heating operation is very power consuming. It often needs at least 30 minutes to increase the temperature of a roasting grating to 200° C.

In view of the imperfectness of the conventional electrical outdoor roasting ovens, the present invention aims to provide a high efficiency electrical outdoor barbecue device that overcomes the problems discussed above.

### SUMMARY OF THE INVENTION

The primary purpose of the present invention is to provide a high efficiency electrical outdoor barbecue device, which comprises a plurality of arc reflective boards that juxtapose each other in a spaced manner to define a residue discharge gap therebetween, heating tube connection end protection boxes, heating tubes, shielding screens, and roasting gratings, which are sequentially deposited, from lower side to upper side, in a roasting basin that has a top opening to which a cover is pivotally connected. Opposite ends of the heating tubes are respectively positioned in and supported by the heating tube connection end protection boxes and the heating tube connection end protection boxes are fit into and retained by positioning cavities defined in corresponding walls of the basin. The shielding screens set above the heating tubes protect the heating tubes from being stained by drippings of roasted food from the roasting gratings. The arc reflective boards set below the heating tubes reflect the infrared light and heat generated by electrical excitement of the heating tubes toward the roasting gratings for fully heating the roasted foods. The heating tubes comprise halogen lighting tubes or carbon fiber lighting tubes. The halogen lighting tube or the carbon fiber lighting tube generates radiation and light, both being used to effect heating, which is completely different from the conventional heating tube that only generate radiation for effecting heating, whereby temperature rise and heating area can both be substantially improved. This will be explained in two respects.

(1) Efficiency of heat supply source is effectively increased. The halogen lighting tube or the carbon fiber lighting tube that is currently available has an electricity-to-heat conversion efficiency greater than 85%. Further, the halogen lighting tube and the carbon fiber lighting tube may induces a surface temperature greater than 700° C. on a glass enclosure surface thereof, which induces infrared light having a wavelength between 780-760 nm. Experiments show that halogen lighting tube having color temperature between 1.9-2.3KK is most suitable for cooking foods. Experiments also show that carbon fiber lighting tube having color temperature between 1.5-1.7KK is most suitable for cooking foods.

(2) The halogen lighting tube and the carbon fiber lighting tube use both light and radiation to simultaneously carry out heating, and this makes the reflective boards disposed below the heating tubes to reflect light more important. The conventionally used reflection means comprises arc shining-surface metal boards that collects heat and uniformly distribute heat to a range covering the roasting grating, so that the drawback of non-uniform distribution of temperature occurring in the conventional electrical heating tube is alleviated.

Thus, a high thermal efficiency can be achieved, which raises the temperature of the roasting grating to 200° C. within 10 minutes after the oven is turned on and at an expense of only consuming heat of 966 BTU. Thus, as compared to the gas-burning oven that raises the temperature of a roasting grating to 200° C. within 12 minutes by consuming 4,800 BTU, the time needed is shorter, the heat consumed is less, and heating can be carried out in a quicker manner than the conventional electrical outdoor roasting oven. This indicates that in the course of transfer of heat, the electrical outdoor barbecue device in accordance with the present invention is subjected to less loss of thermal energy, so that it provides an effect of saving power. This is the primary objective of the present invention.

Further, the high efficiency electrical outdoor barbecue device in accordance with the present invention provides arc reflective boards that are of a construction of easy removal for cleaning. In the course of use, greasy drippings generated by the cooked foods is guided by the descending curvature of the arc reflection boards to pass through a residue discharge gap between the juxtaposing arc reflection boards to be collected in a connection tray set at the bottom of a roasting basin. Since the electrical outdoor barbecue device of the present invention has high efficiency and quick temperature rise, the greasy drippings can maintain a thermally molten flowable condition to drop downward for discharge and formation of sticky grease due to condensation caused by temperature drop during the course of flowing is reduced to thereby eliminate burning of greasy build-up that makes smoke to pollute the atmosphere. This makes food cooked in a more conservative way to the environments. This is another objective of the present invention.

Further, the high efficiency electrical outdoor barbecue device comprises a device cover pivotally connected to a top opening of a roasting basin and the cover is provided with a lining that may comprise a surface-shining metal reflection board to reflect the heat for further effectively heating the cooked food for sealing the good taste inside the food. This is a further objective of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a high efficiency electrical outdoor barbecue device according an embodiment of the present invention.

FIG. 2 is a perspective view of the high efficiency electrical outdoor barbecue device of the present invention in an assembled form.

FIG. 3 is a cross-sectional view of the high efficiency electrical outdoor barbecue device of the present invention.

FIG. 4 is a perspective view of the high efficiency electrical outdoor barbecue device of the present invention with a cover attached thereto.

FIG. 5 is a perspective view showing a closed condition of the cover-attached high efficiency electrical outdoor barbecue device of the present invention.

FIG. 6 is a side elevational view of FIG. 5.

FIG. 7 is a perspective view showing a heating tube of the high efficiency electrical outdoor barbecue device of the present invention.

FIG. 8 is a perspective view showing the high efficiency electrical outdoor barbecue device of the present invention in a condition where roasting gratings are separated therefrom.

FIG. 9 is a perspective view showing the high efficiency electrical outdoor barbecue device of the present invention in a condition where the roasting gratings are separated therefrom and arc reflection boards are withdrawn.

FIG. 10 is a perspective view showing a high efficiency electrical outdoor barbecue device according to another embodiment of the present invention with roasting gratings separated therefrom.

FIG. 11 is a cross-sectional view showing a high efficiency electrical outdoor barbecue device according to a further embodiment of the present invention.

FIG. 12 is a cross-sectional view showing a high efficiency electrical outdoor barbecue device according to a further embodiment of the present invention.

FIG. 13 is a cross-sectional view showing a high efficiency electrical outdoor barbecue device according to a further embodiment of the present invention.

FIG. 14 is a perspective view showing arc reflection boards of a high efficiency electrical outdoor barbecue device according to yet a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

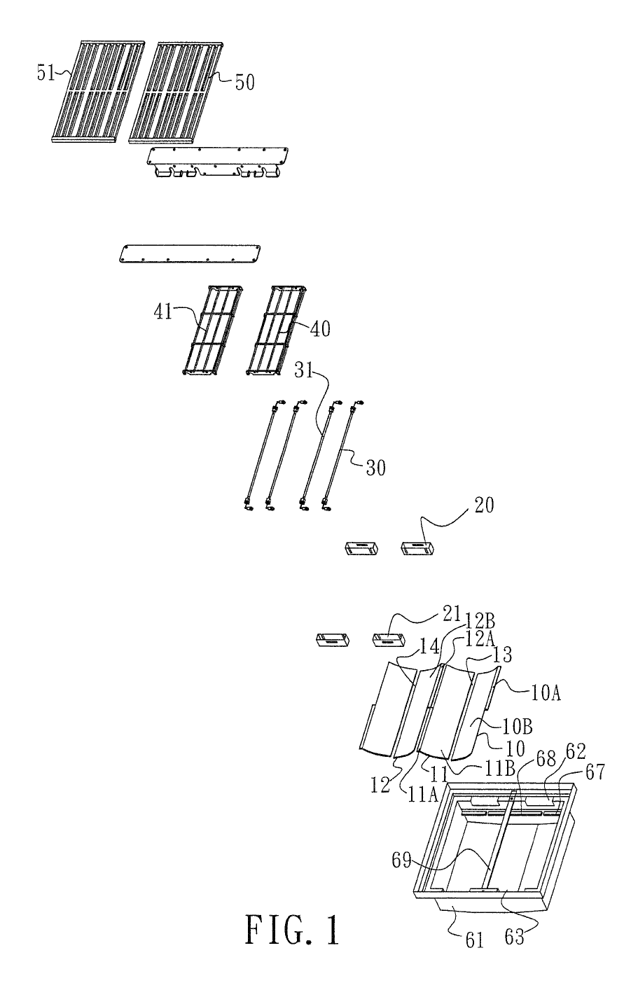

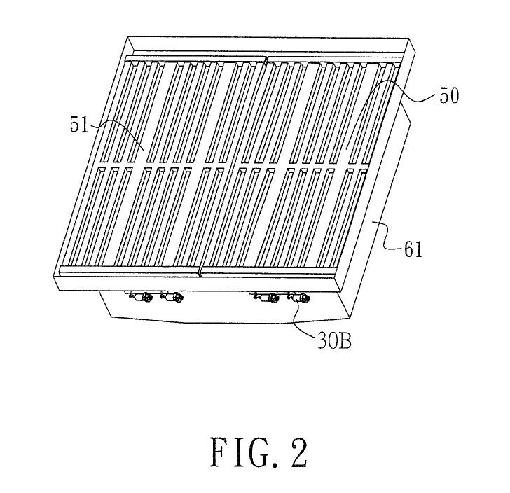

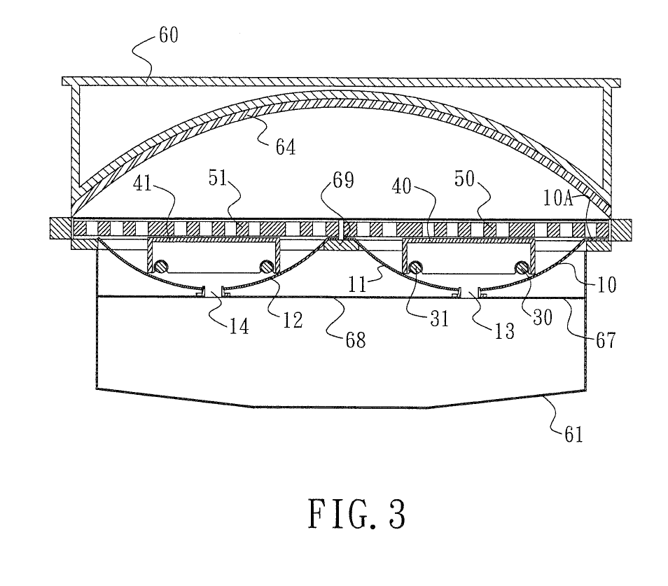

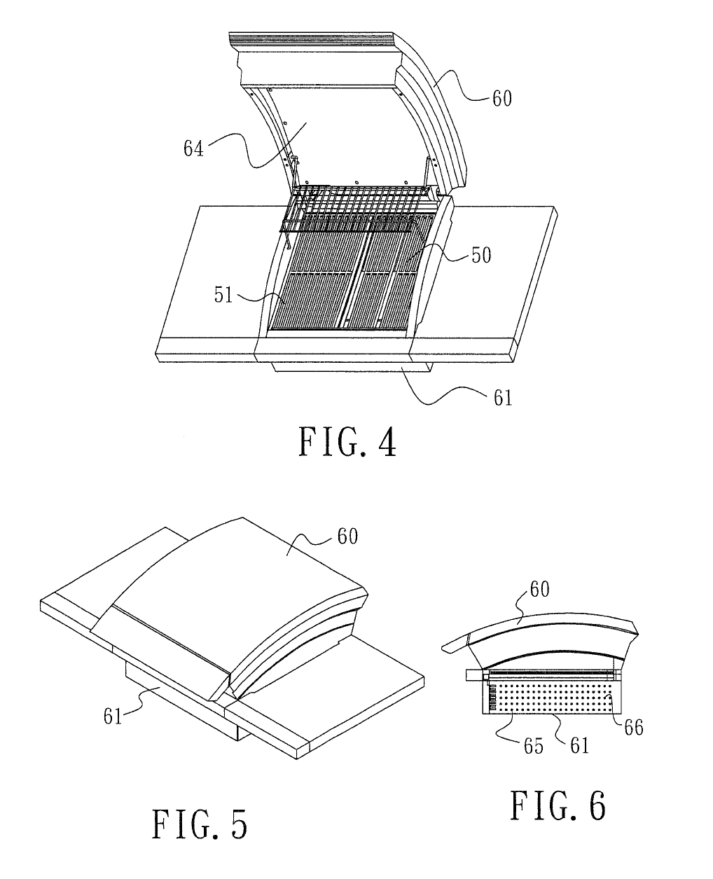

FIG. 1 is an exploded view showing a high efficiency electrical outdoor barbecue device according an embodiment of the present invention. Reference is also made to a perspective view of an assembled form shown in FIG. 2, a cross-sectional view shown in FIG. 3, a perspective view in which a cover is added shown in FIG. 4, a perspective view of a closed condition of added cover shown in FIG. 5, and a side elevational view shown in FIG. 6. As shown in these drawings, the high efficiency electrical outdoor barbecue device according to the present invention comprises a plurality of arc reflective boards 10, 11, 12, 13 that juxtapose each other in a spaced manner to define residue discharge gaps 14, 15 therebetween, heating tube connection end protection boxes 20, 21, heating tubes 30, 31, shielding screens 40, 41, and roasting gratings 50, 51, which are sequentially deposited, from lower side to upper side, in a roasting basin 61 that has a top opening to which a cover 60 is pivotally connected. Corner flanges of the reflective boards 10, 11, 12, 13 that define the residue discharge gaps 14, 15 are positioned on and supported by reflection board supports 67, 68 projecting from inner walls of the roasting basin 61 at a corresponding altitude and opposite edge flanges of the reflective boards 10, 11, 12, 13 are positioned on and supported by wall shoulders of the roasting basin 61 that are for supporting of the roasting gratings 50, 51, whereby the reflective boards 10, 11 show a configuration that is curved downward to exhibit a descending arrangement toward the residue discharge gap 14, 15. Opposite ends of the heating tubes 30, 31 are respectively positioned in and supported by the heating tube connection end protection boxes 20, 21 and the heating tube connection end protection boxes 2, 21 are fit into and retained by positioning cavities 62, 63 defined in corresponding inner walls of the roasting basin 61. The arc reflective boards 10, 11, 12, 13 are set below the heating tubes 30, 31 to reflect infrared light and heat generated by electrical excitement of the heating tubes 30, 31 toward the roasting gratings 50, 51 for fully heating foods to be roasted. As shown in FIG. 4, the cover 60 that is pivotally connected to the top of the roasting basin 61 is selectively and additionally provided with a lining that comprises a surface-shining metal reflection board 64 to reflect the heat generated by the heating tubes 30, 31 from the upper side toward the lower side so that as shown in FIG. 5, the cover 60, when closed, helps to continuously and slowly cook foods and may function to reflect back heat dissipating upward. As shown in FIG. 6, the side walls of the roasting basin 61 selectively define heat dissipation holes 65, 66 at a portion below the roasting gratings 50, 51 to protect the heating tubes 30, 31 against over-heating and thus extending the lifespan thereof

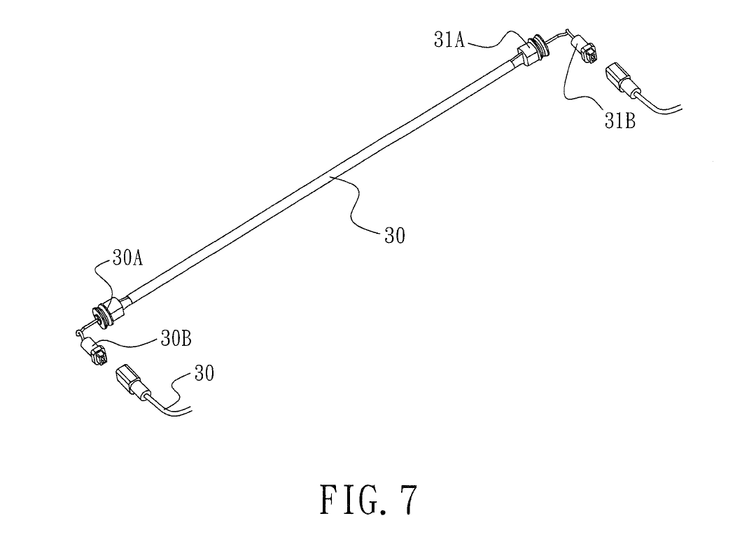

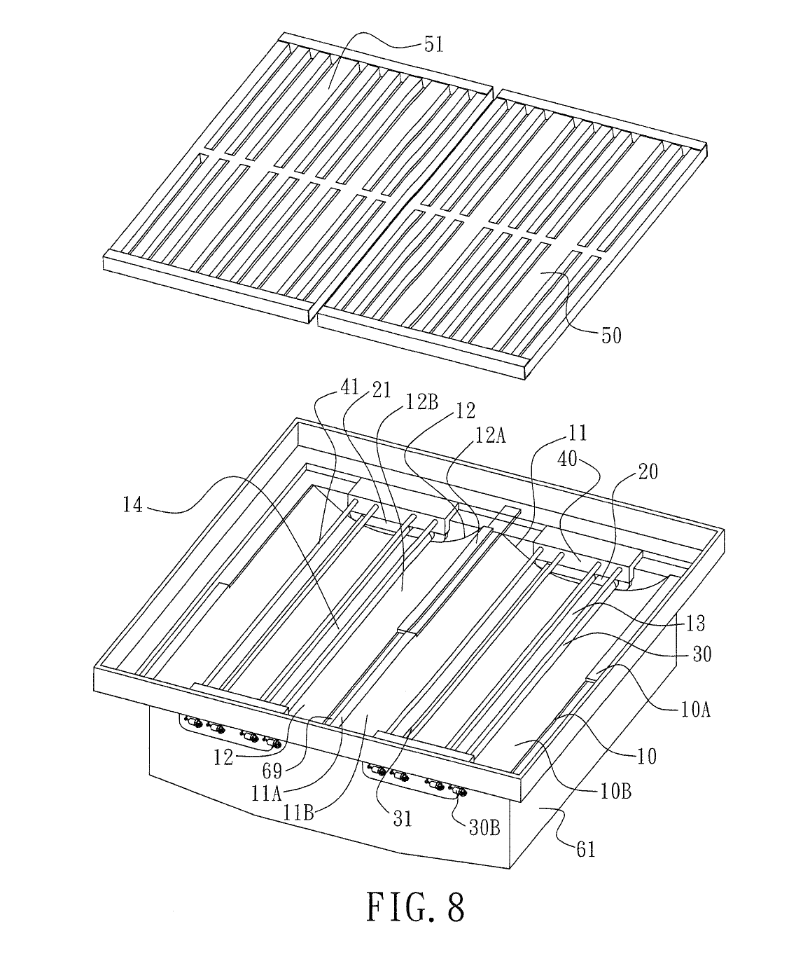

As shown in the perspective view of the heating tube illustrated in FIG. 7, the heating tube 30 may comprise a main body composed of a glass tube enclosed halogen lighting tube or a glass tube enclosed carbon fiber lighting tube. The lighting tube can be one that consumes a power of 400 W at a voltage of 110V, or one that consumers a power of 500 W at a voltage of 230V, both using a current greater than 12 A. Thus, in the structural arrangement of the sites that the heating tube is coupled to the barbecue device body, protective shielding of electrical connections of the heating tube 30 is of importance. As to the structural arrangement of the site of coupling the heating tube 30 to the barbecue device body, as shown in FIG. 6, the shielding screens 40, 41 are set above the heating tubes 30, 31 to form an eaves-like structure for providing a shielding effect to prevent greasy drippings from the roasting gratings 50, 51 from dropping onto the heating tubes 30, 31 to reduce the high operation temperature of the heating tubes 30, 31 and to stain the glass tubes of the heating tubes 30, 31, which often reduces the lifespan of the heating tubes 30, 31. The opposite ends of the heating tubes 30, 31 are additionally provided with temperature-resistant silicone rings 30A, 31A for positioning on the heating tube connection end protection boxes 20, 21 to protect the glass tubes from stress or impact occurring in the transportation and installation thereof, which may damage the glass tubes. Further, as shown in the previous drawings, metal bars that constitute the roasting gratings 50, 51 are widened or expanded to prevent eyesight of a device operator or surrounding persons from directly watching the heating tubes 30, 31 that emit high light and heat so as to cause damage to the eyesight.

As to the safety structure of the electrical connection of the heating tube with wires, since the heating tubes 30, 31 are halogen lighting tubes or carbon fiber lighting tubes that consume an electrical current of more than 12 A, risks of lightning strikes or electrical discharges that cause damage may occur. Male/female connectors of the tube 30 for connection with a power source and the male/female connectors of dedicated power wires 70 are enclosed by temperature-resistant silicone housings 30B, 31B that are of specific and matable configurations, whereby the electrical connection of the heating tube 30 with the wires is isolated from the adjacent ones of the metal boards that constitute the barbecue device body. Even in use in a wet environment, no electrical discharge may occur, making the device of the present invention meet the requirement of safety.

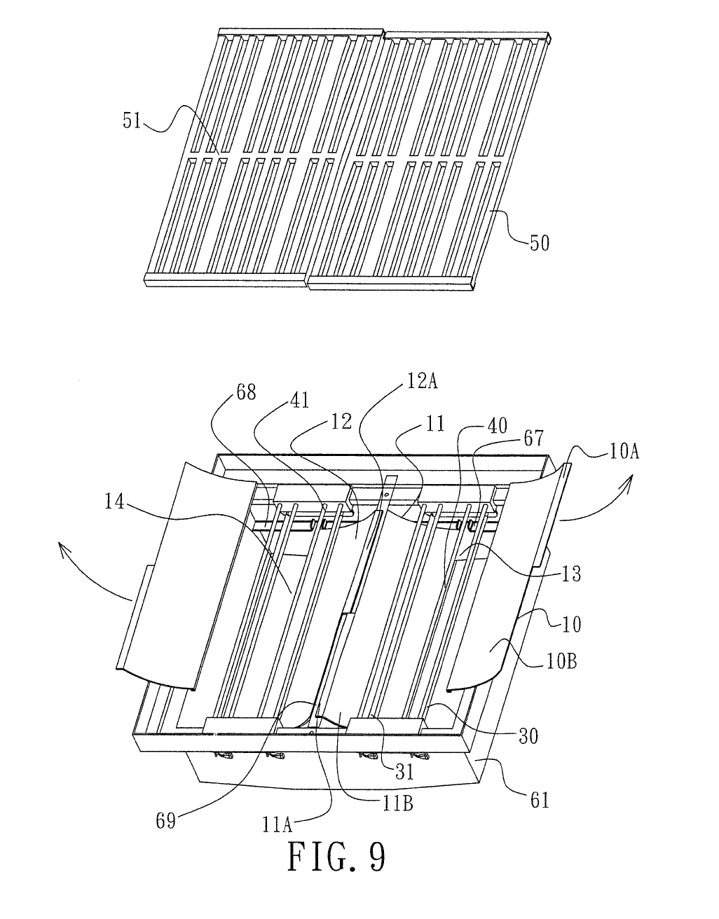

As to the detailed structure of the are reflective boards 10, 11, 12, 13, as shown in the perspective view of FIG. 8 in which the roasting gratings are detached, the reflective boards 10, 11, 12, 13 are supported on the wall shoulders of the roasting basin 61 that support the roasting gratings 50, 51 with edge flanges 10A, 11A, 12A, 13A thereof, which project laterally and extend longitudinally by substantially half the length of the reflective boards 10, 11, 12, 13. The roasting basin 61 comprises a longitudinally-extending support rack 69 that is substantially located at a central position of the wall shoulder of the roasting basin 61 that supports the roasting gratings 50, 51. Edge flanges 11A, 12A of the juxtaposing arc reflective boards 11, 12 that are adjacent to the center are arranged in a longitudinally alternating manner and positioned on and supported by the longitudinal rack 69. With this arrangement, the width of the longitudinal rack 69 can be reduced and the influence of the central rack on the whole roasting surface area is thus reduced. When power is shut down and the roasting gratings 50, 51 are detached after the completion of roasting operation, the reflective boards 10, 11, 12, 13 can be withdrawn for cleaning of staining formed thereon. However, if this is done by moving the reflective boards 10, 11, 12, 13 in the longitudinal direction, the reflective boards 10, 11, 12, 13 may encounter the heating tube connection end protection box 20 and are thus blocked from removal. The operation of withdrawal of the arc reflective boards 10, 11, 12, 13 must be done in the way demonstrated in FIG. 9, wherein the edge flanges 10A, 11A, 12A, 13A are gripped and pulled out in an upward and outward inclined direction along which the arc reflective boards 10, 11, 12, 13 can be completely withdrawn. Thus, the reflective boards 10, 11, 12, 13 can be withdrawn for wiping and cleaning without first removing the shielding screens 40, 41, the heating tube connection end protection boxes 20, 21, and the heating tubes 30, 31. The reflective boards 10, 11, 12, 13 can be put back in the same inclined direction. This process is simple and easy to operate.

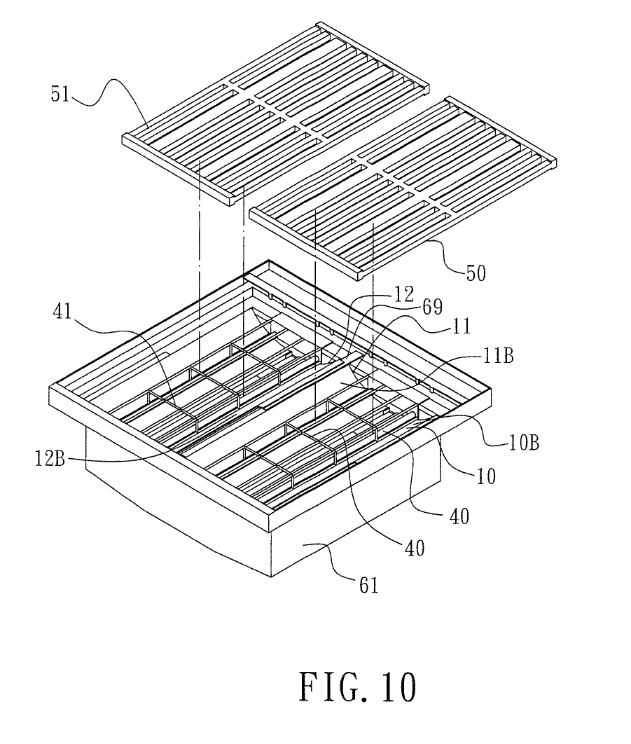

The present invention may also be embodied in the way shown in FIG. 10, which illustrates another embodiment of the high efficiency electrical outdoor barbecue device in accordance with the present invention, wherein the shielding screens 40, 41 are formed in the forms of inverted U-shaped metal shielding screens that house the glass tubes of the heating tubes 30, 31 so as to protect the lighting tubes from being damage by accidental drop of the arc reflective boards 10, 11, 12, 13 and the roasting gratings 50, 51 during their disassembling. The shielding screens 40, 41 that are made in an inverted U-shape also offer, to some extents, protection of the roasting gratings 50, 51 that are located above the shielding screens 40, 41 and the arc reflective boards 10, 11, 12, 13 that are located below the shielding screens 40, 41 against undesired impact and hit.

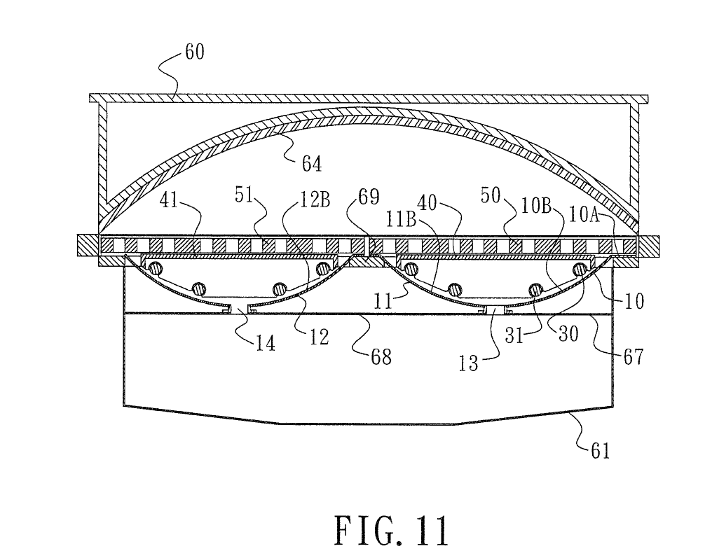

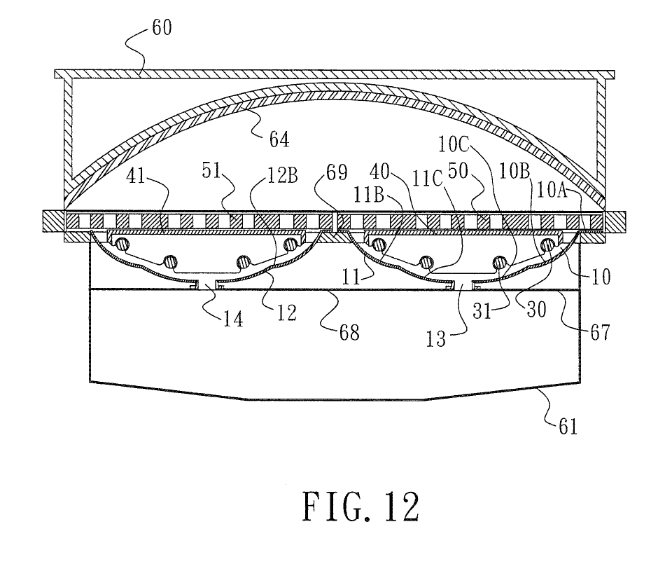

Each arc reflective board 10, 11, 12, 13 can be made in the form composed of a single concavely curved plate section 10B, 11B, 12B, 13B located below a single one of the heating tubes 30, 31 corresponding thereto for condensing the light and heat that project from the heating tube 30, 31 toward the bottom of the basin and then reflecting the light and heat back in an opposite direction. Alternatively, as shown in the embodiment of FIG. 11, each arc reflective board 10, 11, 12, 13 is made in the form composed of a single concavely curved plate section 10B, 11B, 12B, 13B located below multiple ones of the heating tubes 30, 31 corresponding thereto for commonly condensing the lights and heats that project from the multiple heating tubes 30, 31 toward the bottom of the basin and then reflecting the lights and heats back in an opposite direction. Alternatively, as shown in the embodiment of FIG. 12, each arc reflective board 10, 11, 12, 13 is made in the form composed of multiple concavely curved plate sections 10B, 10C, 11B, 11C, 12B, 12C, 13B, 13C each being located below a single one of the heating tubes 30, 31 corresponding thereto for condensing the light and heat that project from the heating tube 30, 31 toward the bottom of the basin and then reflecting the light and heat back in an opposite direction.

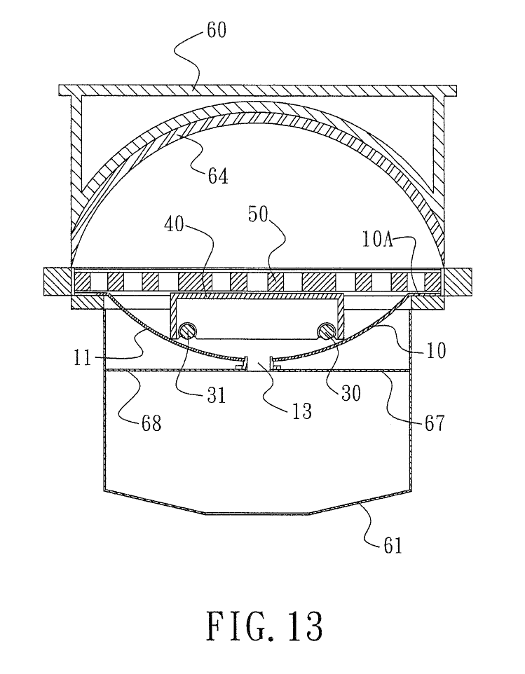

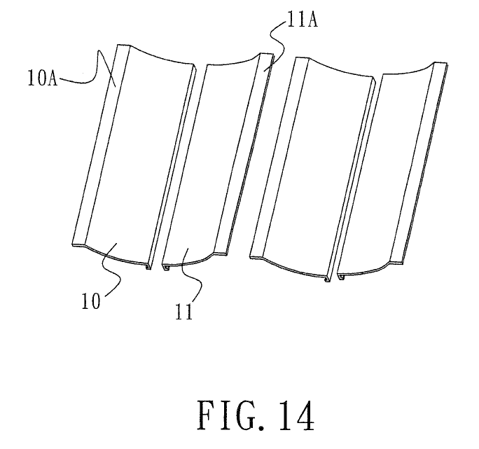

Further, as shown in FIG. 13, the present invention may be constructed in such a way that only two arc reflective boards 10, 11 are used to meet different needs of different applications. Further, as shown in FIG. 14, the arc reflective boards 10, 11 may be constructed so that the edge flanges 10A, 11A of the arc reflective boards 10, 11, which are positioned on and supported by the wall shoulders of the roasting basin 61 that support the roasting gratings 50, 51, extend longitudinally in all the length of the reflective boards 10, 11.

To summarize, the high efficiency electrical outdoor barbecue device in accordance with the present invention is advantageous in providing higher efficiency, more environment conservative, more energy economized, safer and more reliable than the conventionally used gas-burning ovens, carbon-burning ovens, and electrical outdoor roasting ovens, and also offers a novel feature of reflective boards being removable for easy cleaning.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high efficiency electrical outdoor barbecue device, which comprises a plurality of arc reflective boards that juxtapose each other in a spaced manner to define a residue discharge gap therebetween, halogen heating tubes, heating tube connection end protection boxes, shielding screens, and roasting gratings, which are sequentially deposited, from lower side to upper side, in a roasting basin that has a top to which a cover is pivotally connected, opposite ends of the halogen heating tubes being respectively positioned in and supported by the heating tube connection end protection boxes, the heating tube connection end protection boxes being fit into and retained by positioning cavities defined in corresponding walls of the basin, wherein the shielding screens are set above the halogen heating tubes to protect the halogen heating tubes from being stained by drippings of roasted food falling from the roasting gratings, and the arc reflective boards are set below the halogen heating tubes to reflect infrared light and heat generated by electrical excitement of the halogen heating tubes toward the roasting gratings for further heating the roasted foods, so as to provide protection of the halogen heating tubes against staining caused by roasting operation and damage caused by impact and to allow the arc reflective boards to be removed through lateral and upward inclined withdrawal of the reflective boards and re-deposited back into the basin through downward inclined insertion for realizing easy and convenient maintenance.

2. The high efficiency electrical outdoor barbecue device according to claim 1, wherein the cover that is pivotally connected to the top of the roasting basin comprises a lining that comprises a surface-shining metal reflection board to reflect heat from the halogen heating tubes in a direction from upper side to lower side.

3. The high efficiency electrical outdoor barbecue device according to claim 1, wherein each of the halogen heating tubes has a glass enclosure tube having a surface that reaches a temperature greater than 700° C. and generates infrared light having a wavelength between 780-760 nm and color temperature between 1.9-2.3KK.

4. The high efficiency electrical outdoor barbecue device according to claim 1, wherein the opposite ends of the heating tubes are provided with temperature-resistant silicone rings for positioning on the heating tube connection end protection boxes.

5. The high efficiency electrical outdoor barbecue device according to claim 1, wherein the roasting gratings are each composed of metal gratings formed of wide bars to prevent eyesight of users from directly watching the heating tubes.

6. The high efficiency electrical outdoor barbecue device according to claim 1, wherein the heating tubes comprises male/female connectors for connection with a power source and the male/female connectors are enclosed by temperature-resistant silicone housings for selective mating with power wires, whereby the electrical connection of the heating tubes with the wires is isolated from the adjacent metal boards that constitute partly the barbecue device.

7. The high efficiency electrical outdoor barbecue device according to claim 1, wherein inner surfaces of the walls of the roasting basin form inward projecting reflection board supports at a location corresponding to the arc reflective boards so as to support corner flanges of the reflective boards that define the residue discharge gap and wherein the reflective boards have edge flanges positioned on and supported by wall shoulders of the roasting basin that support the roasting gratings so that the reflective boards show a configuration that is curved downward to exhibit a descending arrangement toward the residue discharge gap.

8. The high efficiency electrical outdoor barbecue device according to claim 7, wherein the edge flanges of the reflective boards that are supported on the wall shoulders of the roasting basin that support the roasting gratings project laterally and extend longitudinally by substantially half the length of the reflective boards and wherein the roasting basin comprises a longitudinally-extending support rack that is substantially located at a central position of the wall shoulder of the roasting basin that supports the roasting gratings, the edge flanges of the juxtaposing arc reflective boards that are adjacent to the center being arranged in a longitudinally alternating manner and positioned on and supported by the longitudinal rack.

9. The high efficiency electrical outdoor barbecue device according to claim 1, wherein the shielding screens are made in the form of inverted U-shaped metal shielding screens that house the glass tubular enclosures of the heating tubes.

10. The high efficiency electrical outdoor barbecue device according to claim 1, wherein each of the arc reflective boards comprises a single concavely curved plate section located below a single one of the heating tubes corresponding thereto for condensing light and heat that project from the heating tube toward the bottom of the basin and then reflecting the light and heat back in an opposite direction.

11. The high efficiency electrical outdoor barbecue device according to claim 1, wherein each of the arc reflective boards comprises multiple concavely curved plate sections each located below a single one of the heating tubes corresponding thereto for condensing light and heat that project from the heating tube toward the bottom of the basin and then reflecting the light and heat back in an opposite direction.
